(19) United States
(12) Patent Application Publication
(10) Pub. No.: US 2007/0113742 A1
(43) Pub. Date: May 24, 2007

(54) Scrubber for absorbing ethanol and other VOCs from bakery exhaust

(76) Inventor: Harry Zaphiros, Roselle Park, NJ (US)

Correspondence Address: DAY PITNEY LLP, 7 TIMES SQUARE, NEW YORK, NY, 10036-7311, US

(21) Appl. No.: 11/286,157

(22) Filed: Nov. 23, 2005

(51) Int. Cl. B01D 47/00

(52) U.S. Cl. 96/270

(57) ABSTRACT

A water-based scrubber is used to remove ethanol and other VOCs from the exhaust of a commercial bakery oven, particularly a tunnel oven. The exhaust from the oven is forced through the water of the scrubber so that ethanol and other VOCs become dissolved in the water. The water, including the dissolved ethanol and VOCs, is periodically removed from the scrubber, treated and disposed of through a convention sewer or drain.

### BACKGROUND OF THE INVENTION

1. Field of the Invention

The present invention relates a water-based scrubber for removing ethanol and other VOCs (volatile organic compounds) from the exhaust of a commercial bakery oven.

2. Description of the Prior Art

It is well-known in the prior art that the exhaust from commercial bakery ovens includes ethanol and other VOCs. In particular, the ethanol is formed by yeasts acting upon sugars and starches at the increased temperatures involved in the baking process. This ethanol, along with other VOCs, is considered to be a significant source of air pollution and, therefore, the subject of substantial state and federal regulation. Additionally, this exhaust typically includes particulate (bread crumbs), grease, oil and a high level of moisture.

Moreover, any solution to this problem cannot substantially alter the airflow of the bakery oven, which is critical to the finished product.

A common solution is an oxidizer which creates a flame from an independent fuel source in order to burn the ethanol vapors. Oxidizers, however, are extremely expensive, perhaps as much as a million dollars, and require substantial maintenance and operating expenses. However, as many commercial bakeries, particularly smaller commercial bakeries, are typically low-profit margin, thinly capitalized operations, such a solution is not practical.

### OBJECTS AND SUMMARY OF THE INVENTION

It is therefore an object of the present invention to provide a method and apparatus for removing ethanol and other VOCs from the exhaust of a commercial bakery oven, such as a tunnel oven, thereby meeting environmental regulations.

It is therefore a further object of the present invention to provide a method and apparatus for removing ethanol and other VOCs from the exhaust of a commercial bakery oven, such as a tunnel oven, without adding any further contaminants into the air.

It is therefore a still further object of the present invention to provide a method and apparatus for removing ethanol and other VOCs from the exhaust of a commercial bakery oven, such as a tunnel oven, without causing any substantial odors.

It is therefore a still further object of the present invention to provide a method and apparatus for removing ethanol and other VOCs from the exhaust of a commercial bakery oven, such as a tunnel oven, without substantially changing the airflow balance of the oven.

It is therefore a still further object of the present invention to provide a method and apparatus for achieving the above objects without being excessively expensive or requiring excessive maintenance and operating expenses.

These and other objects are attained by providing a scrubber which includes a tank of water and a blower which urges the exhaust gas through the water. The scrubber passes the exhaust gas of the commercial bakery oven, such as a tunnel oven, through a water bath, which causes the ethanol to separate from the exhaust and mix with the water circulated in the scrubber, with the scrubbed exhaust being released into the atmosphere. The amount of water in the scrubber is maintained and a constant level by a floating device and is refreshed by an automatic valve. The water which is removed from the scrubber is directed to a water treatment room where it is prepared and treated as waste water before being released into a sewer system.

### BRIEF DESCRIPTION OF THE DRAWINGS

Further objects and advantages will become apparent from the following description and claims, and from the accompanying drawings, wherein:

FIG. 1 is a perspective view, partially in phantom, of the scrubber of the present invention.

FIG. 2 is a first cross-sectional view of the scrubber of the present invention.

FIG. 3 is a second cross-sectional view of the scrubber of the present invention.

FIG. 4 is a cross-sectional view of the expansion tank baffle of the scrubber of the present invention.

### DETAILED DESCRIPTION OF THE PREFERRED EMBODIMENT

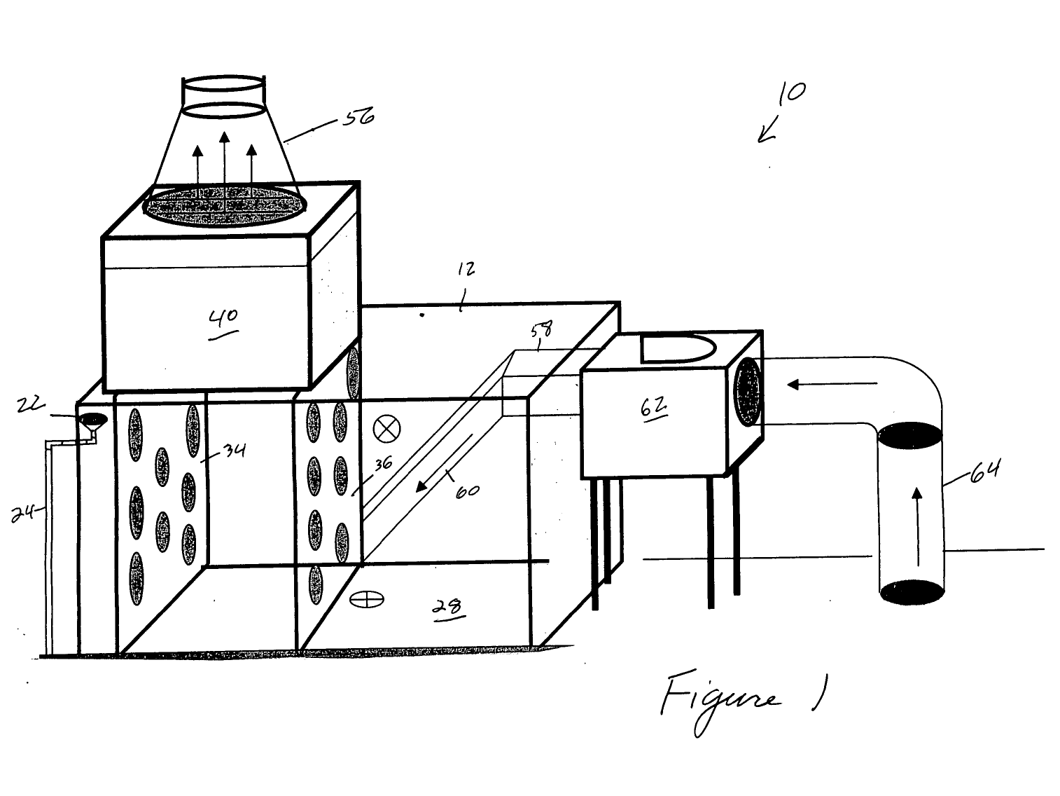

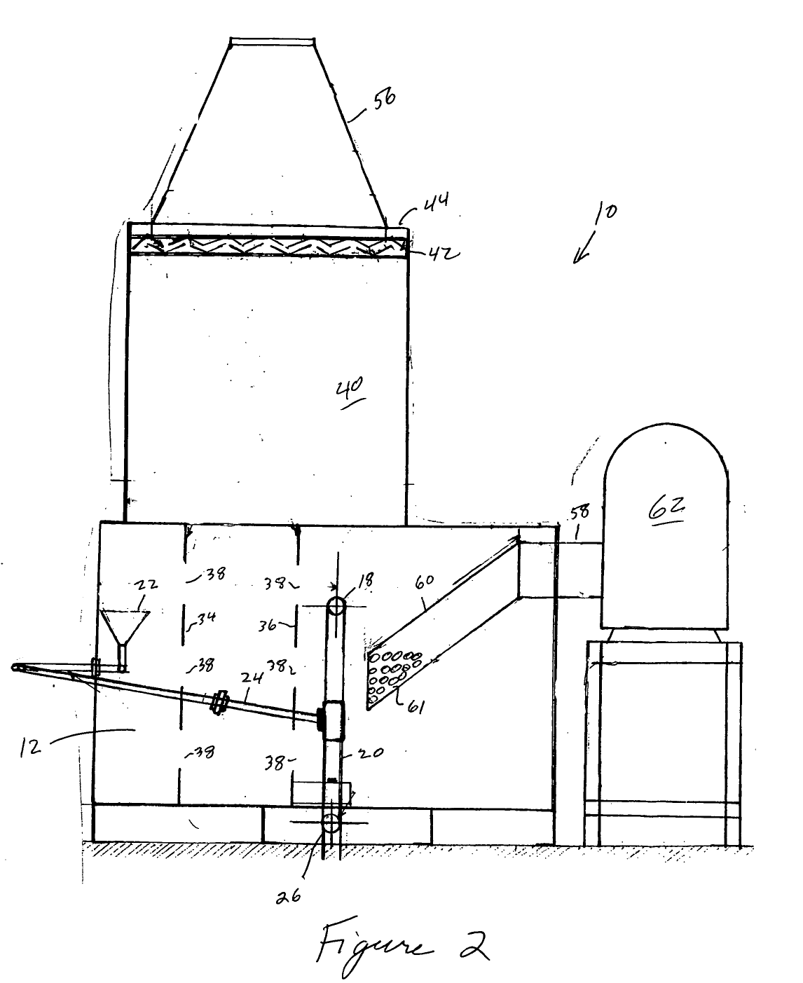

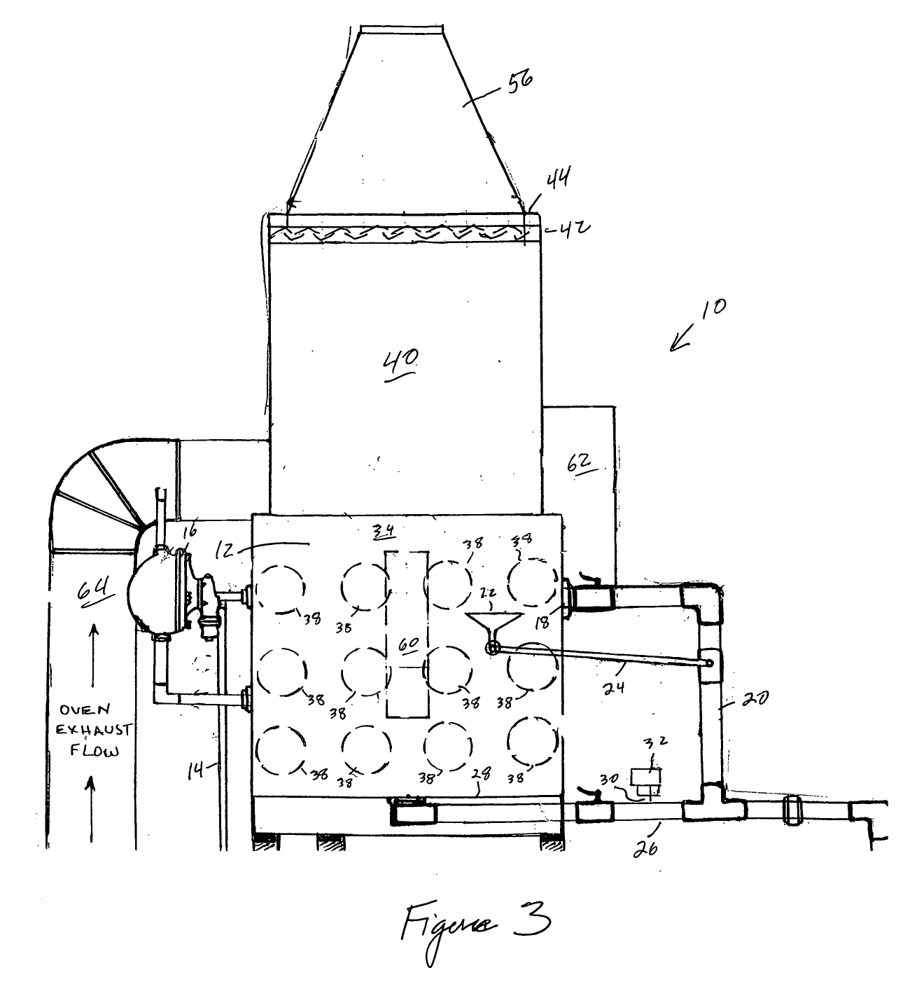

Referring now to the drawings in detail—wherein like numerals indicate like elements throughout the several views, one sees that FIGS. 1-3 are various views of the scrubber 10 of the present invention. Scrubber 10 includes main tank 12 which is typically made from stainless steel (typically stainless steel type 304) and may have a height of 34 inches, a length of 54 inches and a width of 36 inches. However, those skilled in the art will recognize a range of equivalents for this material and dimensions, as well as any other materials and dimensions given herein, after review of the present disclosure.

Main tank 12 includes an inlet water line 14 and a flow device 16 to maintain the water level in main tank 12 of scrubber 10. The level of the water is further controlled or limited by the level of the opening 18 of overflow pipe 20 (typically formed of PVC pipe). Likewise, oil skimmer 22, shaped as an inverted cone, is attached by pipe 24 to overflow pipe 20 and skims oil from the surface of the water, and limits the level of the water in main tank 12. Lower drain pipe 26 opens into the floor 28 of main tank 12 and permits the substantially complete discharging of water from main tank 12 as controlled by discharge water valve 30 controlled, in turn, by timer 32. Lower drain pipe 26 discharges water to treatment module (not shown) which, in turn, typically discharges the treated water into a conventional sewer or drain (not shown).

Main tank baffle plates 34, 36 are formed vertically in main tank 12 between overflow pipe 20 and oil skimmer 22, and are typically formed of 18 gauge stainless steel. Apertures 38 are formed in main tank baffle plates 34, 36 to allow the free flow of liquid therethrough.

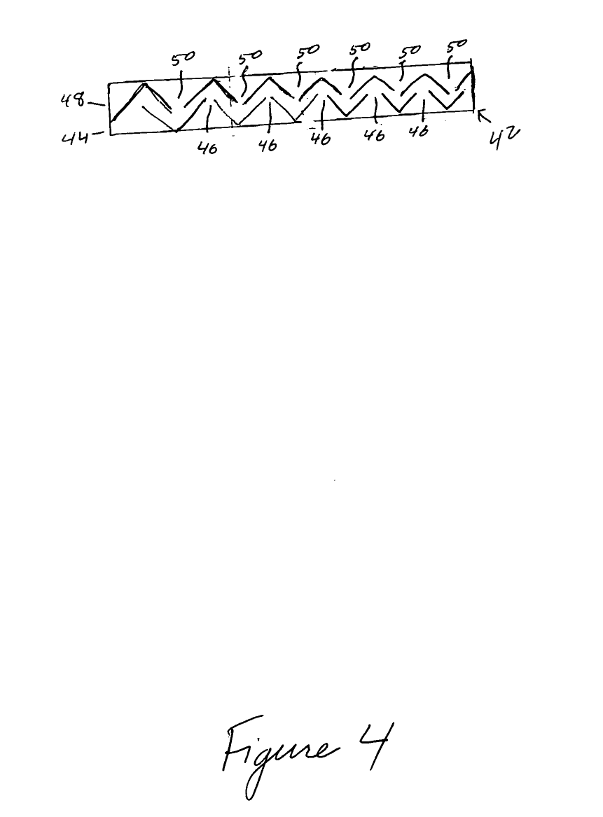

Expansion tank 40 is formed above main tank 12. Expansion tank 40 is typically formed of stainless steel (again, typically stainless steel 304) and may have sides of 32 inches and a height of 36 inches. Expansion tank baffle 42 is formed downwardly adjacent from the upper edge 44 of expansion tank 34. As shown in FIG. 4, expansion tank baffle 42 has a lower row of upwardly facing V-shaped elements 44 with interstices 46 therebetween and a upper row of downwardly facing V-shaped elements 48 with interstices 50 therebetween. The resulting construction causes the exhaust rising through an opening (not shown) in main tank 12 to expansion tank 40 to pass through interstices 46 of the lower row of upwardly facing V-shaped elements 44, to pass diagonally downwardly through the space formed between upwardly facing V-shaped elements 44 and downwardly facing V-shaped elements 48, and then to pass through interstices 50. This inhibits the passing of water through expansion tank baffle 42 as the exhaust rises into conical exhaust pipe 56.

Conical exhaust pipe 56, with an open top and bottom, is typically formed of stainless steel (again, typically stainless steel 304) and may have a lower diameter of 29 inches, an upper diameter of 10 inches and a height of 21½ inches.

Main tank 12 further includes horizontal blower outlet pipe 58 which passes through the wall thereof and engages diagonal blower outlet pipe 60 which extends below the water level (that is, to a level lower than opening 18 of overflow pipe 20). Diagonal blower outlet pipe 60 includes several apertures 61 around the periphery thereof, below the water level. Apertures 61 are typically one inch in diameter and serve to stabilize scrubber 10, particularly at high volumes of exhaust throughput. Horizontal blower outlet pipe 58 receives the outlet of air blower 62. Air blower 62 is typically a radial blade belt drive booster in the 3 to 5 horsepower range, operating at 3450 rpm and having a throughput of 515 to 1780 cubic feet per minute. Air blower 62 receives the exhaust from a commercial bakery through oven exhaust stack 64 and blows the exhaust through outlet pipes 58, 60 so as to pass through the water. This causes at least a portion of the ethanol and other VOCs to dissolve in the water and be removed from the exhaust. The exhaust thereafter passes upwardly from main tank 12, through expansion tank 40 and out of conical exhaust pipe 56.

In order to operate scrubber 10, water is inlet though inlet water line 14 so as to rise to the level of opening 18 of overflow pipe 20. Exhaust from the commercial bakery is thereafter urged through the water as previously described, so as to remove a substantial portion of the ethanol and other VOCs from the exhaust, which ultimately passes out of conical exhaust pipe 56. Periodically, timer 32 activates discharge water valve 30 to allow the water to drain through lower drain pipe 36. The water is treated by directed to a water treatment room where it is prepared and treated as waste water before being released into a sewer system.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A scrubber for removing ethanol from the exhaust of a bakery oven, comprising:
a main tank for containing water;
a pipe extending below the surface of the water; and
a blower for forcing exhaust from a bakery oven through said pipe and into said water, thereby causing at least a portion of the ethanol in the exhaust to dissolve in the water.

2. The scrubber of claim 1 further including a first drain for controlling the level of the water in said main tank during operation.

3. The scrubber of claim 2 further including a second drain for removing substantially all of the water from said main tank.

4. The scrubber of claim 3 wherein said second drain is activated by a timer so as to periodically remove substantially all of the water from said main tank.

5. The scrubber of claim 4 further including an expansion tank above said main tank whereby the exhaust, after rising from the water, travels from said main tank to said expansion tank.

6. The scrubber of claim 5 further including an exhaust pipe through which the exhaust passes after passing through said expansion tank.

7. The scrubber of claim 6 further including an expansion baffle within said expansion tank.

8. The scrubber of claim 7 wherein said expansion baffle includes a lower row of upwardly extending V-shaped elements with first interstices therebetween and an upper row of downwardly extending V-shaped elements with second interstices therebetween.

9. The scrubber of claim 8 further including an oil skimmer in said main tank.

10. The scrubber of claim 9 wherein said main tank includes vertical baffles with apertures therethrough.

11. The scrubber of claim 10 wherein said vertical baffles are placed between said oil skimmer and said first drain.

12. The scrubber of claim 11 wherein said pipe includes peripheral apertures below a level of water as determined by said first drain.
